(19) United States
(12) Patent Application Publication
(10) Pub. No.: US 2025/0044751 A1
(43) Pub. Date: Feb. 6, 2025

(54) DIGITAL TWIN ENHANCED METHOD AND SYSTEM FOR DETECTING AND COMPENSATING COMPLEX EQUIPMENT

(71) Applicant: SHANDONG UNIVERSITY, Jinan, Shandong (CN)

(72) Inventors: Tianliang HU, Jinan (CN); Lili DONG, Jinan (CN); Fei TAO, Jinan (CN)

(73) Assignee: SHANDONG UNIVERSITY, Jinan, Shandong (CN)

(21) Appl. No.: 18/292,022

(22) PCT Filed: Mar. 15, 2023
(86) PCT No.: PCT/CN2023/081708

§ 371 Date: Jan. 25, 2024

(30) Foreign Application Priority Data
Jun. 23, 2022 (CN) 202210718996.4

(51) Int. Cl. G05B 13/02

(52) U.S. Cl. CPC G05B 13/027

(57) ABSTRACT

A digital twin (DT) enhanced method and system for detecting and compensating complex equipment, including: firstly intelligently deciding detection strategies that adapt to personalized scenarios based on a complex equipment and operating scenario fused DT model; then, autonomously implementing the detection strategies based on a complex equipment and detection device fused DT model, and location and quantitative errors according to detection results; and finally, deciding and implementing a compensation solution fused with an operating process based on a complex equipment and controller fused DT model. A complex equipment DT system is deeply fused with time varying operating scenarios, a detection device and a control system, and the adaptive capability of the detection strategies to personalized operating objects and the time varying operating process, the autonomous implementation and analysis capability of variable strategy detection, and the coupling implementation capability of the compensation and operating process are improved.

The present invention claims the priority of the Chinese Patent Application 202210718996.4 filed on Jun. 23, 2022, and entitled “DIGITAL TWIN ENHANCED METHOD AND SYSTEM FOR DETECTING AND COMPENSATING COMPLEX EQUIPMENT”, which is incorporated herein by reference in its entirety.

### TECHNICAL FIELD

The present invention belongs to the technical field of industrial equipment intelligentization and digitization, and in particular relates to a digital twin enhanced method and system for detecting and compensating complex equipment.

### BACKGROUND

Precision complex equipment represented by computer numerical control machine tools, lithography machines, etc. is industrial core strategic materials, is the foundation of key industries such as military industry and people's livelihood, and is an industrial mother machine for practicing intelligent manufacturing. For high-precision complex equipment, the operating precision of the complex equipment is an important index for measuring its performance. However, due to the coupling influence caused by errors in geometry, thermal, force, control, processes, etc. in its working process, with the time varying of an operating environment, it brings great challenges to detection and precision improvement. Therefore, how to scientifically detect operating errors and effectively improve the precision is a key problem needing to be immediately solved.

The inventor discovers that at present, improving the operating precision through an error online detection and compensation method is the most direct and effective precision improvement measure. The detection and compensation process generally includes three steps: detection strategy making, detection strategy implementation, and detection result use. However, most strategies are constant strategies in the detection strategy making step, which does not take the influence of the time varying of operating scenarios into consideration, due to the fact that a detection strategy deciding model is not fused with the equipment/operating environment. The detection strategy implementation generally depends on relatively independent detection devices, which lack flexible adaptability to the variable detection strategy implementation and error analysis, due to the fact that a detection strategy implementation model is not fused with detection devices. Compensation is performed by modifying compensation parameters of a controller based on detection results, which is a fixed compensation method, has poor adaptability, and is difficult to implement complex compensation strategies, due to the fact that a detection result compensation model is not deeply fused with an operating process controller.

### SUMMARY

In order to solve the above problems, the present invention provides a digital twin (DT) enhanced method and system for detecting and compensating complex equipment. The present invention deeply fuses a complex equipment DT system with time varying operating scenarios, built-in/external detection devices and a control system by using a DT technology, so as to improve the adaptive capability of the detection strategies to personalized operating objects and the time varying operating process, the autonomous implementation and analysis capability of variable strategy detection, and the coupling implementation capability of the compensation and operating process, and improve the operating precision of the complex precise equipment.

In order to achieve the above purpose, the present invention is implemented through the following technical solution:

In a first aspect, the present invention provides a DT enhanced method for detecting and compensating complex equipment, including:

obtaining real-time sensor data and historical operating data of complex equipment, operating scenarios of the complex equipment, detection devices and a controller.

A detection and compensation module is configured to build a complex equipment and operating scenario fused DT model, a complex equipment and detection device fused DT model, and a complex equipment and controller fused DT model according to the obtained real-time sensor data, the obtained historical operating data, operating mechanism modeling, and intelligent algorithms, to obtain detection and compensation strategies for the complex equipment, and perform detection and compensation on the complex equipment.

The complex equipment and operating scenario fused DT model, the complex equipment and detection device fused DT model, and the complex equipment and controller fused DT model are obtained through model assembly and fusion; firstly, the detection strategies that adapt to personalized scenarios are intelligently decided based on the complex equipment and operating scenario fused DT model; then, the detection strategies are autonomously implemented based on the complex equipment and detection device fused DT model, and errors are located and quantified according to detection results; and finally, a compensation solution fused with an operating process is decided and implemented based on the complex equipment and controller fused DT model.

Further, the detection device includes built-in detection devices and external detection devices. The built-in detection device refers to detection components and signal processing devices inside the complex equipment. The external detection device includes an external sensor library, a sensor location tooling library, and a detection robot. The controller refers to a control system supporting compensation strategy implementation.

Further, feature extraction, feature classification and state detection are performed by using statistical analysis, genetic algorithms and support vector machine data algorithms based on complex equipment data and operating scenario data, and sensor state information of the complex equipment and the operating scenarios are analyzed. The sensor state information of the complex equipment and the operating scenarios include historical state information and the real-time sensor state information.

The complex equipment and operating scenario fused DT model is built based on modeling software, the analyzed state information of the complex equipment and the operating scenarios, and Krylov subspace projection methods, Bayesian methods or analytic hierarchy processes.

Further, based on the complex equipment and operating scenario fused DT model, mutual influence mechanism analysis and data analysis are performed between the complex equipment and the operating scenarios by using a neural network or a support vector machine, detection manners and detection areas are determined, and detection strategies that adapt to personalized operating scenarios are generated.

Further, feature extraction, feature classification and state detection are performed by using statistical analysis, genetic algorithms and support vector machine data algorithms based on complex equipment data and detection device data, and sensor state information of the complex equipment and the detection device are analyzed. The sensor state information of the complex equipment and the detection device includes historical state information and the real-time sensor state information.

The complex equipment and detection device fused DT model is built based on modeling software, the analyzed state information of the complex equipment and the detection device, and Krylov subspace projection methods, Bayesian methods or analytic hierarchy processes. Variable detection strategies generated at a former stage are implemented, the complex equipment and detection device fused DT model is run, and equipment structure and detection device fused detection data for a detection solution is obtained.

A detection device and error analysis system is designed according to the fused detection data; and furthermore, a DT mechanism model of the complex equipment is run, error quantitative and location analysis is performed by using a neural network, a support vector machine and an expert system, and the compensation strategies for the operating process of complex equipment are generated.

Further, feature extraction, feature classification and state detection are performed by using statistical analysis, genetic algorithms and support vector machine data algorithms based on complex equipment data and controller data, and sensor state information of the complex equipment and the controller are analyzed. The sensor state information of the complex equipment and the controller includes historical state information and the real-time sensor state information.

The complex equipment and controller fused DT model is built based on modeling software, the analyzed sensor state information of the complex equipment and the controller, and Krylov subspace projection methods, Bayesian methods or analytic hierarchy processes. The complex equipment and controller fused DT model is run, and DT based decision strategies of fusing multi-compensation measures with operating process are generated through the compensation strategies generated at a former stage, so that operating errors may be controlled.

Further, the compensation solution includes operating motion trail compensation, operating process parameter compensation, equipment thermal deformation compensation, and tooling compensation.

In a second aspect, the present invention further provides a DT enhanced system for detecting and compensating complex equipment, including:
a data acquisition module, configured to obtain real-time sensor data and historical operating data of complex equipment, operating scenarios of the complex equipment, detection devices and a controller; and
a detection and compensation module, configured to build a complex equipment and operating scenario fused DT model, a complex equipment and detection device fused DT model, and a complex equipment and controller fused DT model according to the obtained real-time sensor data, the obtained historical operating data, operating mechanism modeling, and intelligent algorithms, to obtain detection and compensation strategies for the complex equipment, and perform detection and compensation on the complex equipment.

The complex equipment and operating scenario fused DT model, the complex equipment and detection device fused DT model, and the complex equipment and controller fused DT model are obtained through model assembly and fusion; firstly, the detection strategies that adapt to personalized scenarios are intelligently decided based on the complex equipment and operating scenario fused DT model; then, the detection strategies are autonomously implemented based on the complex equipment and detection device fused DT model, and errors are located and quantified according to detection results; and finally, a compensation solution fused with an operating process is decided and implemented based on the complex equipment and controller fused DT model.

In a third aspect, the present invention further provides a computer-readable storage medium which stores a computer program. The program implements the steps of the DT enhanced method for detecting and compensating complex equipment according to the first aspect when being executed by a processor.

In a fourth aspect, the present invention further provides an electronic device which includes a memory, a processor and a computer program stored on the memory and configured to run on the processor. The processor implements the steps of the DT enhanced method for detecting and compensating complex equipment according to the first aspect when executing the program.

Compared with the prior art, the present invention has the following beneficial effects:
1. In the present invention, firstly, the detection strategies that adapt to personalized scenarios are intelligently decided based on the complex equipment and operating scenario fused DT model; then, the detection strategies are autonomously implemented based on the complex equipment and detection device fused DT model, and the errors are located and quantified according to detection results; and finally, the compensation solution fused with the operating process is decided and implemented based on the complex equipment and controller fused DT model. The complex equipment DT system is deeply fused with the time varying operating scenarios, the detection device and the control system by using the DT technology, the adaptive capability of the detection strategies to the personalized operating objects and the time varying operating process, the autonomous implementation and analysis capability of variable strategy detection, and the coupling implementation capability of the compensation and operating process are improved, and the operating precision of the complex precision equipment is improved.
2. The present invention uses the DT technology to explore a dynamic decision-making method for complex equipment DT and its operating scenario fused detection strategies in terms of the problem of dynamic selection of detection strategies under variable operating objects, variable operating parameters and variable operating environments, and overcomes the limitation of scenario adaptation of conventional constant detection strategies.
3. The present invention uses the DT technology to explore an equipment DT and detection device fusion driven detection data obtaining and error tracing method in terms of the problems of difficulty in detection data obtaining and difficulty in error origin tracing caused by variable detection strategies, and solves the problems of intelligent autonomous implementation of the variable detection strategies and the high-precision error source location and quantification.
4. The present invention uses the DT technology to explore a complex equipment DT and controller fused compensation control method in terms of the coupling problem of the dynamic error compensation solution and the complex equipment operating process, and implements the fusion control of the operating process and the compensation process.

### BRIEF DESCRIPTION OF THE DRAWINGS

The accompanying drawings constituting a part of embodiments of the present invention are used to provide a further understanding for the embodiments. Exemplary ones of the embodiments and descriptions thereof are used to explain the embodiments, and do not constitute an improper limitation of the embodiments.

FIG. 1 is a schematic structural diagram of Embodiment 1 of the present invention.

FIG. 2 is a schematic structural diagram of built-in/external detection devices according to Embodiment 1 of the present invention.

FIG. 3 is a schematic structural diagram of a fusion process of DT based complex equipment and operating scenarios according to Embodiment 1 of the present invention.

FIG. 4 is a schematic structural diagram of a fusion process of the DT based complex equipment and the built-in/external detection device according to Embodiment 1 of the present invention.

FIG. 5 is a schematic structural diagram of a fusion process of the DT based complex equipment and a controller according to Embodiment 1 of the present invention.

FIG. 6 is a schematic structural diagram of a DT virtual-real interaction module according to Embodiment 2 of the present invention.

### DETAILED DESCRIPTION

The present invention will be further illustrated hereafter in combination with accompanying drawings and embodiments.

It should be noted that, the following detailed descriptions are all exemplary, and are intended to provide further descriptions of the present application. Unless otherwise specified, all technical and scientific terms used herein have the same meanings as those usually understood by a person of ordinary skill in the art to which the present application belongs.

Complex equipment refers to precise complex equipment represented by computer numerical control machine tools, lithography machines, etc.

### Embodiment 1

As mentioned in the background, how to implement cyber-physical deep fusion of a detection and compensation process is one of challenges of the precise and efficient implementation of detection and compensation method for complex precision equipment. In terms of the problem of precise and efficient implementation of detection and compensation method for complex precision equipment caused by complicated origins of operating errors of the complex equipment and time varying with environments, as shown in FIG. 1, this embodiment provides a DT enhanced method for detecting and compensating complex equipment, including:

Real-time sensor data and historical operating data of the complex equipment, operating scenarios of the complex equipment, detection devices and a controller are obtained. Specifically, the states of the complex equipment, the operating scenarios of the complex equipment, the detection device and the controller may be sensed through a sensing system, and real-time sensor data and historical operating multiple sensor data in physical space are synchronously obtained.

The obtained real-time sensor data and historical operating data are mapped to digital space.

In the digital space, a complex equipment and operating scenario fused DT model, a complex equipment and detection device fused DT model, and a complex equipment and controller fused DT model are sequentially built based on the operating mechanism modeling, the real-time sensor data and historical operating data modeling, and intelligent algorithms. The detection device may include built-in detection devices and external detection devices.

Application analysis is sequentially performed on three fusion DT models. Through analysis, decision and control, the efficient detection and compensation on complex precise equipment are implemented, and the operating precision is improved. Specifically, the detection strategies that adapt to personalized scenarios are intelligently decided based on the complex equipment and operating scenario fused DT model; then, the detection strategies are autonomously implemented based on the complex equipment and detection device fused DT model, and high-precision errors are located and quantified according to detection results; and finally, a compensation solution fused with an operating process is decided and implemented based on the complex equipment and controller fused DT model.

The controller refers to a control system supporting the implementation of variable compensation strategies. The controller may be obtained through an existing control system, and may also be obtained through secondary development on a secondary development interface of an existing control system. The controller with a capability of dynamically fusing the compensation solution with the operating process includes a numerical control device, an input/output device, a driving device, etc.

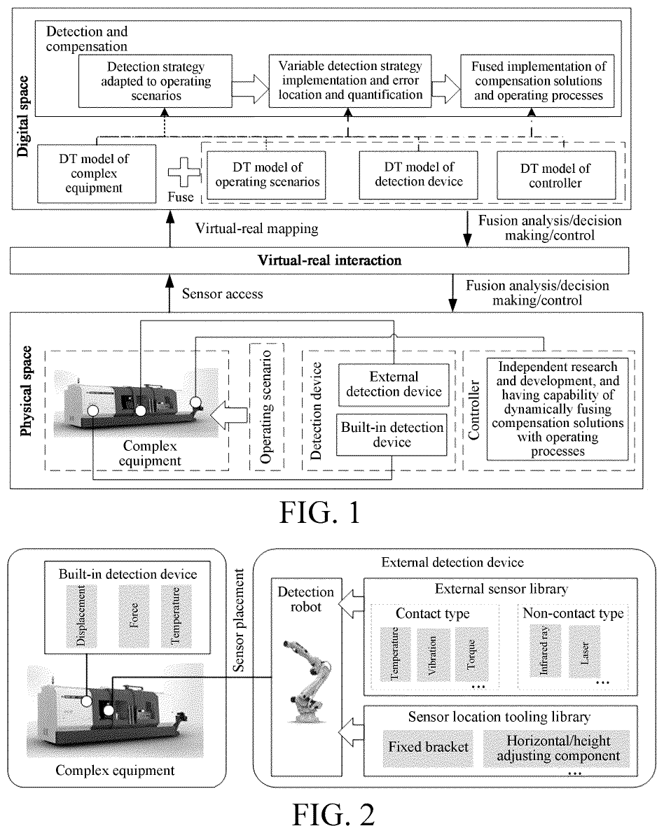

As shown in FIG. 2, the built-in/external detection device is a system device for complex equipment detection and compensation. The built-in detection device refers to detection components and signal processing devices inside the complex equipment, and can measure relevant data of geometry, force, temperature, etc. of an object to be measured in real time. The external detection device consists of an external sensor library, a sensor location tooling library, and a detection robot. The external sensor library may include sensors for force, torque, temperature, vibration, displacement, etc. The sensor may be in a contact type, and may also be in a non-contact type such as a laser or an infrared. The placement and location of external sensors inside the machine are implemented through the detection robot and sensor location tooling.

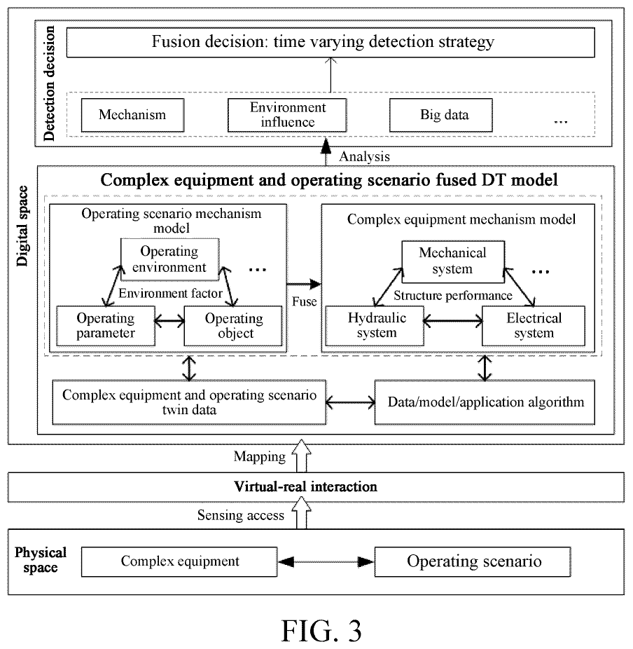

As shown in FIG. 3, the development of a real-time decision system for detection strategy adapting to personalized operating scenarios and suitable for time varying operating process is completed through the complex equipment and operating scenario fused DT model. The implementation process may include:

For the operating state of the complex equipment in the operating scenarios, taking the equipment structures, variable operating objects, variable operating parameters and variable operating environments into consideration, the real-time sensor data and historical operating data of the complex equipment and the operating scenarios are mapped.

Based on the mapped data of the complex equipment and operating scenarios, feature extraction, feature classification, state detection, etc. may be performed through data algorithms such as statistical analysis algorithms, genetic algorithms and support vector machine algorithms to analyze the sensor state information of the complex equipment and the operating scenarios. The sensor state information of the complex equipment and the operating scenarios includes historical state information and real-time sensor state information. A DT model is updated in real time through the real-time sensor state information, so that the built complex equipment and operating scenario fused DT model has better timeliness.

The complex equipment and operating scenario fused DT model is built based on operating mechanism modeling software supporting Modelica/Simscape modeling languages, the analyzed state information of the complex equipment and the operating scenarios, and model reduction, correction and simplification algorithms such as Krylov subspace projection methods, Bayesian methods and/or analytic hierarchy processes.

Based on the complex equipment and operating scenario fused DT model, mutual influence mechanism analysis and data analysis are performed between the complex equipment and the environment by using application algorithms such as a neural network, a support vector machine, an expert system, etc., sensitive detection manners and sensitive detection areas are determined, and variable detection strategies that adapt to personalized operating scenarios are generated.

The equipment structures, operating objects, operating parameters and operating environments may include structure features of the complex equipment, parameter attributes and quantities of the operating objects, and the temperature of the operating scenarios. The structure features may include geometry, motion, etc. The temperature of the operating scenarios may be variable or constant.

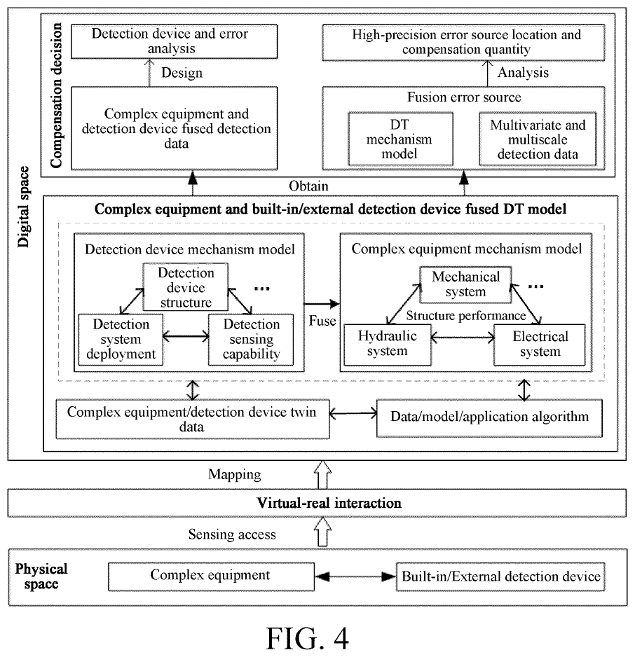

As shown in FIG. 4, the complex equipment and detection device fused DT model is built to develop a high-precision error location and quantitative system implementing the time varying detection strategies, and its implementation process includes:

According to the time varying detection strategies generated by the complex equipment and operating scenario fused DT model, taking the structure features of the complex equipment, the detection capability of the detection device and the deployment manner of the detection device into consideration, the real-time sensor data and the historical operating data of the complex equipment and the detection device are mapped.

Based on the mapped data of the complex equipment and the detection device, the sensor state information of the complex equipment and the detection device may be analyzed through feature extraction, feature classification, state detection, etc. by using data algorithms such as statistical analysis, genetic algorithms and support vector machine data algorithms. The sensor state information of the complex equipment and the detection device includes historical state information and real-time sensor state information. A DT model is updated in real time through the real-time sensor state information, so that the built complex equipment and detection device fused DT model has better timeliness.

The complex equipment and built-in/external detection device fused DT model is built based on operating mechanism modeling software supporting Modelica/Simscape modeling languages, the analyzed state information of the complex equipment and the detection device, and model reduction, correction and simplification algorithms such as Krylov subspace projection methods, Bayesian methods and/or analytic hierarchy processes.

Variable detection strategies generated at a former stage are implemented, the complex equipment and detection device fused DT model is run, and equipment structure and detection device fused detection data for a detection solution is obtained.

A detection device and error analysis system is designed according to the fused detection data. Furthermore, the DT mechanism model of the complex equipment is run, error quantitative and location analysis is performed by using application algorithms such as a neural network, a support vector machine and an expert system, and the compensation strategies for the operating process of complex equipment are generated.

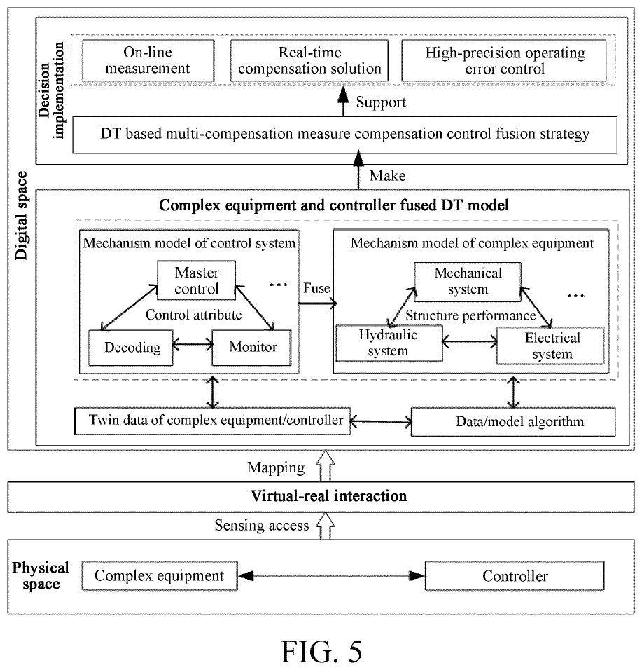

As shown in FIG. 5, the complex equipment and controller fused DT model is built to develop a DT enabling control system implementing the compensation solution fused with the operating process, and its implementation process includes:

According to the error location and quantitative result obtained through complex equipment and detection device fusion, taking the structure features of the complex equipment and the control features of the controller into consideration, the real-time sensor data and historical operating data of the complex equipment and controller are mapped.

Based on the mapped data of the complex equipment and the controller, feature extraction, feature classification, state detection, etc. may be performed through data algorithms such as statistical analysis algorithms, genetic algorithms and support vector machine algorithms to analyzed the sensor state information of the complex equipment and the controller. The sensor state information of the complex equipment and the controller includes historical state information and real-time sensor state information. A DT model is updated in real time through the real-time sensor state information, so that the built complex equipment and controller fused DT model has better timeliness.

The complex equipment and controller fused DT model is built based on operating mechanism modeling software supporting Modelica/Simscape modeling languages, the analyzed state information of the complex equipment and the controller, and model reduction, correction and simplification algorithms such as Krylov subspace projection methods, Bayesian methods and/or analytic hierarchy processes.

The complex equipment and controller fused DT model is run, and DT based decision strategies of fusing multi-compensation measures with operating process are generated through the compensation strategies generated at a former stage, so that high-precision operating error control may be implemented.

The compensation solution may include operating motion trail compensation, operating process parameter compensation, equipment thermal deformation compensation, tooling compensation, etc.

Based on the above, based on the DT virtual-real synchronous mapping capability, this embodiment firstly builds an error formation mechanism model of the complex equipment in time varying environments, discloses the coupling effect mechanism of the operating scenarios and the complex equipment, determines the sensitive detection manners and sensitive detection areas, performs dynamic detection strategy decision, and implements the fused decision making of the complex equipment error formation mechanism and the operating environment. Then, the complex equipment and detection device fused DT model is built to guide the detection measure to adapt to the complex equipment structures, multivariate variable-frequency detection data acquisition and multivariate and multiscale detection data fusion analysis are performed, and the efficient implementation of variable detection strategies and the error analysis are implemented. Finally, the complex equipment and controller fused DT model is built to implement the deep matching of the control process and the complex equipment compensation solution, and the variable-error compensation solution and control solution are efficiently and accurately implemented. The complex equipment and detection and compensation process fused DT model formed in the whole process may guide the detection strategy making, and variable detection strategy analysis and implementation, and may implement the efficient compensation in deep fusion with the operating process.

### Embodiment 2

This embodiment provides a DT enhanced system for detecting and compensating complex equipment, including:
a data acquisition module, configured to sense the states of a complex equipment, operating scenarios of the complex equipment, detection devices and a controller through the sensing system, and synchronously acquire real-time sensor and historically operating multiple sensor data in physical space;
a virtual-real interaction module, configured to map the obtained real-time sensor data and historical operating data to digital space;
a complex equipment and detection and compensation process fusion module, configured to sequentially build a complex equipment and operating scenario fused DT model, a complex equipment and detection device fused DT model, and a complex equipment and controller fused DT model in the digital space based on the operating mechanism modeling, real-time sensor and historical operating data modeling, and intelligent algorithms; and
a complex equipment detection and compensation module, configured to sequentially perform application analysis on three fused DT models, and implement efficient detection and compensation of the complex precise equipment through analysis, decision and control to improve the operating precision. Firstly, the detection strategies that adapt to personalized scenarios are intelligently decided based on the complex equipment and operating scenario fused DT model; then, the detection strategies are autonomously implemented based on the complex equipment and built-in/external detection device fused DT model, and high-precision errors are located and quantified according to detection results; and finally, a compensation solution fused with an operating process is decided and implemented based on the complex equipment and controller fused DT model.

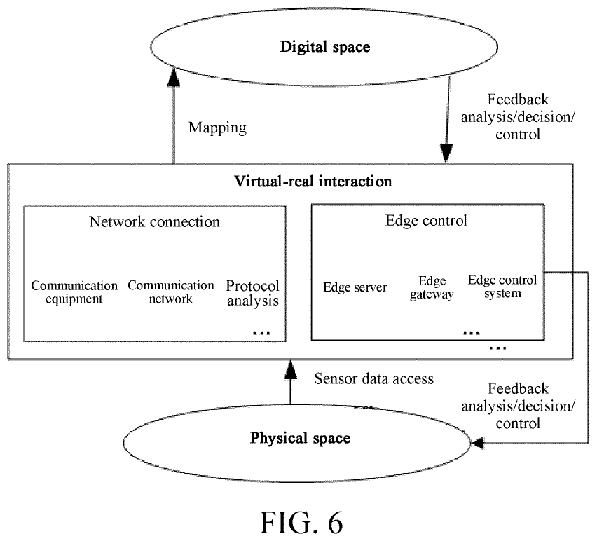

As shown in FIG. 6, the DT virtual-real interaction module is an intermediate link connecting physical space with digital space, is responsible for data mapping and information interaction, and consists of network connections, edge control, etc. The network connections include communication equipment, communication networks, protocol analysis, etc., and can perform analysis, conversion and communication on different transmission protocols sensing multi-source heterogeneous data in the physical space, for example, TCP/IP protocols, PLC protocols, 5G, etc. Edge servers, edge gateways, edge control systems, etc. are utilized. The edge control may exert the real-time sensing and control capability, connect the sensing/communication between the physical space and the digital space, and feed back fusion analysis, decision and guidance instructions of the digital space to the physical space.

The operating method of the system is the same as the DT enhanced method for detecting and compensating complex equipment according to Embodiment 1, and will not be repeated herein.

### Embodiment 3

This embodiment provides a DT enhanced system for detecting and compensating complex equipment, including:
a data acquisition module, configured to obtain real-time sensor data and historical operating data of complex equipment, operating scenarios of the complex equipment, detection devices and a controller; and
a detection and compensation module, configured to build a complex equipment and operating scenario fused DT model, a complex equipment and detection device fused DT model, and a complex equipment and controller fused DT model according to the obtained real-time sensor data, the obtained historical operating data, operating mechanism modeling, and intelligent algorithms, to obtain detection and compensation strategies for the complex equipment, and perform detection and compensation on the complex equipment.

The complex equipment and operating scenario fused DT model, the complex equipment and detection device fused DT model, and the complex equipment and controller fused DT model are obtained through model assembly and fusion; firstly, the detection strategies that adapt to personalized scenarios are intelligently decided based on the complex equipment and operating scenario fused DT model; then, the detection strategies are autonomously implemented based on the complex equipment and detection device fused DT model, and errors are located and quantified according to detection results; and finally, a compensation solution fused with an operating process is decided and implemented based on the complex equipment and controller fused DT model.

The operating method of the system is the same as the DT enhanced method for detecting and compensating complex equipment according to Embodiment 1, and will not be repeated herein.

### Embodiment 4

This embodiment provides a computer-readable storage medium which stores a computer program. The program implements the steps of the DT enhanced method for detecting and compensating complex equipment according to Embodiment 1 when being executed by a processor.

### Embodiment 5

This embodiment provides an electronic device which includes a memory, a processor and a computer program stored on the memory and configured to run on the processor. The processor implements the steps of the DT enhanced method for detecting and compensating complex equipment according to Embodiment 1 when executing the program.

The above descriptions are merely exemplary embodiments of this embodiment, but are not intended to limit this embodiment. For those skilled in the art, various modifications and variations may be made on this embodiment. Any modification, equivalent substitution, improvement, etc. made within the spirit and principles of this embodiment shall fall within the protection scope of this embodiment.

1. A digital twin (DT) enhanced method for detecting and compensating complex equipment, comprising:
obtaining real-time sensor data and historical operating data of complex equipment, operating scenarios of the complex equipment, detection devices and a controller, wherein
a detection and compensation module is configured to build a complex equipment and operating scenario fused DT model, a complex equipment and detection device fused DT model, and a complex equipment and controller fused DT model according to the obtained real-time sensor data, the obtained historical operating data, operating mechanism modeling, and intelligent algorithms, to obtain detection and compensation strategies for the complex equipment, and perform detection and compensation on the complex equipment;
the complex equipment and operating scenario fused DT model, the complex equipment and detection device fused DT model, and the complex equipment and controller fused DT model are obtained through model assembly and fusion; firstly, the detection strategies that adapt to personalized scenarios are intelligently decided based on the complex equipment and operating scenario fused DT model; then, the detection strategies are autonomously implemented based on the complex equipment and detection device fused DT model, and errors are located and quantified according to detection results; and finally, a compensation solution fused with an operating process is decided and implemented based on the complex equipment and controller fused DT model.

2. The DT enhanced method for detecting and compensating complex equipment according to claim 1, wherein the detection device comprises built-in detection devices and external detection devices; the built-in detection device refers to detection components and signal processing devices inside the complex equipment; the external detection device comprises an external sensor library, a sensor location tooling library, and a detection robot; and the controller refers to a control system supporting compensation strategy implementation.

3. The DT enhanced method for detecting and compensating complex equipment according to claim 1, further comprising: performing feature extraction, feature classification and state detection by using statistical analysis, genetic algorithms and support vector machine data algorithms based on complex equipment data and operating scenario data, and analyzing sensor state information of the complex equipment and the operating scenarios, wherein the sensor state information of the complex equipment and the operating scenarios comprises historical state information and the real-time sensor state information; and
building the complex equipment and operating scenario fused DT model based on modeling software, the analyzed state information of the complex equipment and the operating scenarios, and Krylov subspace projection methods, Bayesian methods or analytic hierarchy processes.

4. The DT enhanced method for detecting and compensating complex equipment according to claim 3, further comprising: based on the complex equipment and operating scenario fused DT model, performing mutual influence mechanism analysis and data analysis between the complex equipment and the operating scenarios by using a neural network or a support vector machine, determining detection manners and detection areas, and generating detection strategies that adapt to personalized operating scenarios.

5. The DT enhanced method for detecting and compensating complex equipment according to claim 1, further comprising: performing feature extraction, feature classification and state detection by using statistical analysis, genetic algorithms and support vector machine data algorithms based on complex equipment data and detection device data, and analyzing sensor state information of the complex equipment and the detection device, wherein the sensor state information of the complex equipment and the detection device comprises historical state information and the real-time sensor state information;
building the complex equipment and detection device fused DT model based on modeling software, the analyzed state information of the complex equipment and the detection device, and Krylov subspace projection methods, Bayesian methods or analytic hierarchy processes; implementing variable detection strategies generated at a former stage, operating the complex equipment and detection device fused DT model, and obtaining equipment structure and detection device fused detection data for a detection solution;
designing a detection device and error analysis system according to the fused detection data; and furthermore, running a DT mechanism model of the complex equipment, performing error quantitative and location analysis by using a neural network, a support vector machine and an expert system, and generating the compensation strategies for the operating process of complex equipment.

6. The DT enhanced method for detecting and compensating complex equipment according to claim 1, further comprising: performing feature extraction, feature classification and state detection by using statistical analysis, genetic algorithms and support vector machine data algorithms based on complex equipment data and controller data, and analyzing sensor state information of the complex equipment and the controller, wherein the sensor state information of the complex equipment and the controller comprises historical state information and the real-time sensor state information; and
building the complex equipment and controller fused DT model based on modeling software, the analyzed sensor state information of the complex equipment and the controller, and Krylov subspace projection methods, Bayesian methods or analytic hierarchy processes; and operating the complex equipment and controller fused DT model, generating DT based decision strategies of fusing multi-compensation measures with operating process through the compensation strategies generated at a former stage, and implementing the control on operating errors.

7. The DT enhanced method for detecting and compensating complex equipment according to claim 6, wherein the compensation solution comprises operating motion trail compensation, operating process parameter compensation, equipment thermal deformation compensation, and tooling compensation.

8. A DT enhanced system for detecting and compensating complex equipment, comprising:
a data acquisition module, configured to obtain real-time sensor data and historical operating data of complex equipment, operating scenarios of the complex equipment, detection devices and a controller; and
a detection and compensation module, configured to build a complex equipment and operating scenario fused DT model, a complex equipment and detection device fused DT model, and a complex equipment and controller fused DT model according to the obtained real-time sensor data, the obtained historical operating data, operating mechanism modeling, and intelligent algorithms, to obtain detection and compensation strategies for the complex equipment, and perform detection and compensation on the complex equipment, wherein
the complex equipment and operating scenario fused DT model, the complex equipment and detection device fused DT model, and the complex equipment and controller fused DT model are obtained through model assembly and fusion; firstly, the detection strategies that adapt to personalized scenarios are intelligently decided based on the complex equipment and operating scenario fused DT model; then, the detection strategies are autonomously implemented based on the complex equipment and detection device fused DT model, and errors are located and quantified according to detection results; and finally, a compensation solution fused with an operating process is decided and implemented based on the complex equipment and controller fused DT model.

9. A computer-readable storage medium, storing a computer program, the program implementing the steps of the DT enhanced method for detecting and compensating complex equipment according to claim 1 when being executed by a processor.

10. An electronic device, comprising a memory, a processor, and a computer program stored on the memory and configured to run on the processor, the processor implementing the steps of the DT enhanced method for detecting and compensating complex equipment according to claim 1 when executing the program.
